(19) United States
(12) Patent Application Publication
(10) Pub. No.: US 2006/0199893 A1
(43) Pub. Date: Sep. 7, 2006

(54) Method and system of compounding fiber reinforced thermoplastic

(75) Inventors: Rudolph Schrempf, Brampton (CA); Bradford Armstrong, Barrie (CA); Ranjit K. Singh, Aurora (CA)

Correspondence Address: Warn, Hoffmann, Miller & LaLone, P.C., P.O. Box 70098, Rochester Hills, MI, 48307, US

(73) Assignee: Magna International Inc., Aurora (CA)

(21) Appl. No.: 11/366,090

(22) Filed: Mar. 2, 2006

Related U.S. Application Data
(60) Provisional application No. 60/658,113, filed on Mar. 3, 2005.

(51) Int. Cl. C08K 3/40; C08K 3/04

(52) U.S. Cl. 524/494; 524/495

(57) ABSTRACT

Systems and methods are provided for compounding a thermoplastic melt for molding articles, the melt being reinforced with reinforcing fibers. The thermoplastic material is plasticized with an adhesion promoting agent to obtain an initial melt to which the reinforcing fibers are added. The thermoplastic material forms bonds to bond reception sites on the reinforcing fibers to obtain an intermediate melt to which one or more desired additives, such as a colorant, are then added to obtain the final melt. By forming the intermediate melt without the presence of the one or more desire additives, competition between the one or more desired additives and the thermoplastic material for the bond reception sites is prevented, as is damage to the reinforcing fibers from abrasives in the one or more desired additives. Articles molded with the resulting final melt have improved mechanical properties compared to articles made with prior art methods and systems.

### CROSS-REFERENCE TO RELATED APPLICATION

The instant application claims priority to U.S. Provisional Patent Application Ser. No. 60/658,113, filed Mar. 3, 2005, the entire specification of which is expressly incorporated herein by reference.

### FIELD OF THE INVENTION

The present invention relates to a method and system of compounding fiber reinforced thermoplastic. More specifically, the present invention relates to methods and systems for compounding thermoplastics reinforced with fibers, wherein the mechanical properties of articles formed from the resulting compositions are better than that typically achieved with prior art methods.

### BACKGROUND OF THE INVENTION

It is known to injection mold large articles, such as automotive running boards and the like, from thermoplastic materials such as polypropylene. When such articles must carry relatively large loads, reinforcing fibers, such as glass fibers, are often added to the thermoplastic melt to obtain a reinforced molded article. Typically, as much as 40% fibers, by weight, are added to the thermoplastic melt to achieve this reinforcement.

In general, the longer the fibers in the resulting article, the better the mechanical properties, such as improved impact resistance and overall toughness, of the resulting molded article. Glass fibers having lengths between a third of an inch to one half an inch are commonly used to reinforce polypropylene and it is often desired to employ even longer fibers. However, it can be difficult to compound fibers into the thermoplastic melt as the fibers are broken to shorter lengths through the compounding process.

For example, it is not unusual that when one half inch glass fibers are compounded, the average length of the fibers in the finished article is one quarter of an inch, or less, as the fibers have been damaged during the compounding process.

For handling purposes, fibers are typically introduced into the compounding process in the form of small bundles of fibers held together with binder and these bundles must be de-bundled and the fibers are dispersed throughout the melt during the compounding process to achieve the desired homogeneous blend of reinforcement fibers and thermoplastic. An adhesion promoter, which assists in the bonding of the thermoplastic resin to the glass fibers, is also typically added to the melt during the compounding process to enhance the bonding of the thermoplastic to the fibers.

When molding finished parts, i.e. those for which a cosmetic finish is important, it is also typical to add a ultraviolet blocker and a colorant to the compounding of the melt to impart a final color and a degree of UV resistance to the molded article

Thus the compounding process must deal with the thermoplastic material (which is typically in the form of pellets of material), colorants, adhesion promoters and/or UV blockers.

U.S. Pat. Nos. 5,165,941 and 5,185,117 to Hawley, the entire specifications of both of which are expressly incorporated herein by reference, show an extruder process and system for compounding polypropylene and glass fibers and these systems have been in use for some time. However, when these systems are used in the molding of finished parts, the mechanical properties of the finished part with a colorant and UV blocker are significantly less than a similar unfinished part without a colorant and UV blocker. Further, the tensile strength of finished and unfinished parts is significantly less than might theoretically be achieved.

Accordingly, there exists a need for methods and systems for compounding thermoplastics reinforced with fibers, wherein the mechanical properties of articles formed from the resulting compositions are better than that typically achieved with prior art methods.

### SUMMARY OF THE INVENTION

It is an object of the present invention to provide a novel system and method of compounding fiber reinforced thermoplastic which obviates or mitigates at least one disadvantage of the prior art.

According to a first aspect of the present invention, there is provided a method for compounding a thermoplastic melt for molding articles, the thermoplastic melt being reinforced with fibers, the method comprising: (1) plasticizing a mixture of thermoplastic material and an adhesion promoting agent to obtain an initial melt; (2) supplying fibers to the initial melt and mixing the fibers therein to allow the initial melt to bond to reception sites on the fibers to achieve an intermediate melt; (3) mixing to the intermediate melt at least one additive which would have inhibited bonding between the thermoplastic material and the reinforcing fibers to obtain a final melt; and (4) supplying the final melt for molding of an article.

Preferably, the thermoplastic material is selected from the group comprising polypropylene, Nylon, PET, ABS, TPO and thermoplastic polyurethane. Also preferably, the reinforcing fibers are selected from the group comprising glass, aramid, carbon and natural fibers, such as but not limited to hemp. Also preferably, where the fibers are supplied in bundles of fibers, the method further includes the step of heating and de-bundling the fibers prior to supplying the fibers to the initial melt.

According to another aspect of the present invention, there is provided a system for compounding a thermoplastic melt for molding articles, the melt reinforced with fibers, the system comprising: (1) a first extruder to receive and plasticize a mixture of thermoplastic material and an adhesion promoting agent to obtain an initial melt; (2) a second extruder to receive a supply of fibers and to mix the supply of fibers with the initial melt to obtain an intermediate melt; and (3) an access port through which at least one additive is added to the intermediate melt and mixed therewith to obtain a final melt.

The present invention provides a system and method for compounding a thermoplastic melt for molding articles, the melt being reinforced with reinforcing fibers. The thermoplastic material is plasticized with an adhesion promoting agent to obtain an initial melt to which the reinforcing fibers are added. The thermoplastic material forms bonds to reception sites on the fibers to obtain an intermediate melt to which one or more desired additives, such as but not limited to a colorant, are then added to obtain the final melt. By forming the intermediate melt without the presence of the one or more desire additives, competition between the one or more desired additives and the thermoplastic material for the reception sites on the fibers is prevented, as is damage to the fibers from abrasives in the one or more desired additives. Articles molded with the resulting final melt can have improved mechanical properties compared to articles made with prior art methods and systems.

In accordance with a first embodiment of the present invention, a method for compounding a thermoplastic melt for molding articles is provided, the thermoplastic melt being reinforced with fibers, comprising: (1) plasticizing a mixture of thermoplastic material and an adhesion promoting agent to obtain an initial melt; (2) supplying fibers to the initial melt and mixing the fibers therein to allow the initial melt to bond to reception sites on the fibers to achieve an intermediate melt; (3) mixing to the intermediate melt at least one additive operable to inhibit bonding between the thermoplastic material and the reinforcing fibers to obtain a final melt; and (4) supplying the final melt for molding of an article.

In accordance with a second embodiment of the present invention, a system for compounding a thermoplastic melt for molding articles is provided, the melt reinforced with fibers, comprising: (1) a first extruderto receive and plasticize a mixture of thermoplastic material and an adhesion promoting agent to obtain an initial melt; (2) a second extruder to receive a supply of fibers and to mix the supply of fibers with the initial melt to obtain an intermediate melt; and (3) an access port through which at least one additive is added to the intermediate melt and mixed therewith to obtain a final melt.

In accordance with a third embodiment of the present invention, a thermoplastic melt for molding articles is provided, comprising: (1) a thermoplastic material; (2) an adhesion promoting agent; (3) reinforcing fibers; and (4) at least one additive, wherein the thermoplastic material and the adhesion promoting agent are mixed to obtain an initial melt, wherein the reinforcing fibers are mixed with the initial melt to form an intermediate melt, wherein the at least one additive is mixed with the intermediate melt to form a final melt.

In accordance with a fourth embodiment of the present invention, an article formed from a thermoplastic melt is provided, comprising: (1) a thermoplastic material; (2) an adhesion promoting agent; (3) reinforcing fibers, wherein the adhesion promoting agent is operable to cause a substantial amount of the reinforcing fibers to adhere to the thermoplastic material; and (4) at least one additive.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Preferred embodiments of the present invention will now be described, by way of example only, with reference to the attached Figures, wherein:

FIG. 1 shows a schematic representation of a prior art compounding system and method;

FIG. 2 shows a schematic representation of a compounding system in accordance with the present invention;

FIG. 3 shows a schematic representation of another embodiment of a compounding system in accordance with the present invention;

FIG. 4 shows a schematic representation of another embodiment of a compounding system in accordance with the present invention;

FIG. 5 shows a schematic representation of another embodiment of a compounding system in accordance with the present invention;

FIG. 6 shows a SEM micrograph representing a section of a product made in accordance with previous methodologies; and

FIG. 7 shows a SEM micrograph representation of a section of product made in accordance with the present invention.

### DETAILED DESCRIPTION OF THE INVENTION

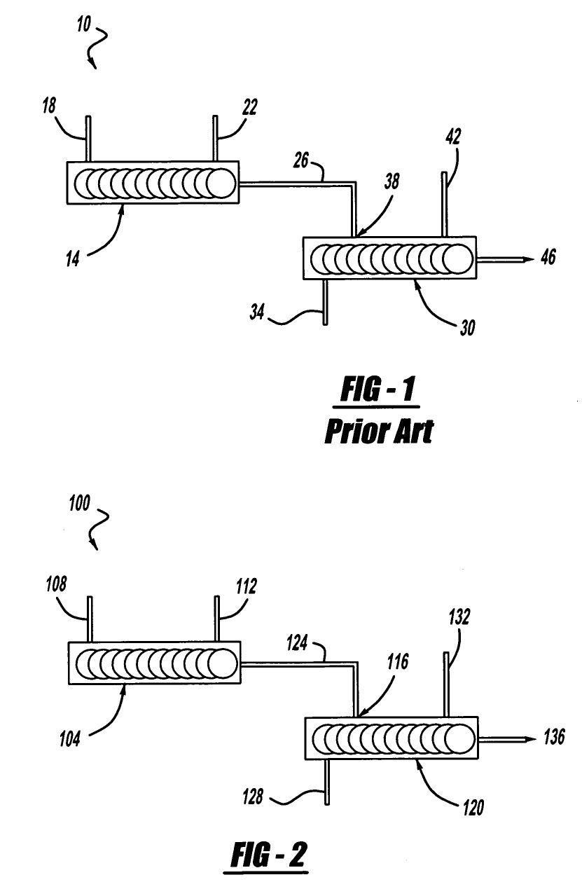

A schematic view of a prior art compounding system and method is indicated at 10 in FIG. 1. System 10 comprises a first extruder 14, in the form of a plasticizing screw, which has an inlet 18 into which the materials to make up the melt, typically pellets of thermoplastic material such as but not limited to polypropylene resin and/or regrind of such a resin, colorants, UV blockers, an adhesion promoter (used to enhance the adhesion between the thermoplastic materials and the reinforcing fibers), is introduced.

As the materials move along the first extruder 14, they are preferably melted and compounded by the screw through frictional heating, compression and mixing. A vent 22 can preferably be provided some distance along the first extruder 14 to preferably permit the venting of gases produced by the melt process and such vents are preferably located in decompression zones of the screw wherein the melt is essentially being mixed without being further compressed. In some melt compounding processes, instead of adding a solid colorant at inlet 18, a liquid colorant can preferably be added at vent 22.

The melt from first extruder 14 is preferably supplied, via a suitable conduit 26, to a second extruder 30. Second extruder 30 also preferably comprises a plasticizing screw and preferably has an inlet 34 into which reinforcing fibers such as but not limited to glass fibers are preferably introduced. As illustrated, inlet 34 is preferably upstream of the inlet 38 where conduit 26 preferably introduces the melt from extruder 14 into second extruder 30. The reinforcing fibers, binder and sizing materials are introduced at inlet 34 and are mixed and preheated between inlet 34 and inlet 38. Once the melt is introduced at inlet 38 the reinforcing are then de-bundled and are preferably mixed with the melt along the remaining length of extruder 30.

As was the case with extruder 14, extruder 30 can preferably be equipped with a vent 42 to preferably allow venting of gasses from the melt in extruder 30.

The resulting melt of thermoplastic material, UV blocker, colorant and reinforcing fibers then preferably exits extruder 30 from an exit port 46 and is preferably supplied to a mold or shooting pot, or is preferably used to form a preform for molding and/or the like.

Articles made from the melt of system 10 preferably have mechanical properties which are less than that which should be able to be achieved. As used herein, the term“mechanical properties” is intended to encompass one or more of tensile strength, impact resistance, resistance to crack propagation, flexural strength, or other desirable mechanical properties.

To date, much attention has been applied to the length of the reinforcing fibers in the final melt and, typically, the average length of these fibers is significantly reduced from the average length of the fibers introduced at inlet 34 and thus it is apparent that the fibers are being damaged in extruder 30. Accordingly, the mechanical properties of products molded from the melt are inferior to what they would be if the fiber length had been maintained.

In the past, various attempts to alter the design of extruder 30 have been made in attempts to reduce the damage to the fibers in extruder 30. But, while some improvements have been obtained, the mechanical properties of products molded from the melt supplied by extruder 30 have been less than is desired.

It is believed that two factors contribute to the reduction in the mechanical properties obtained from fiber reinforced thermoplastic melt compounds.

First, the present invention has determined that reinforcing fibers, such as but not limited to glass fibers, have reception sites along the length of the fibers wherein a bond can form between the thermoplastic materials and the fibers. In system 10, materials such as but not limited to colorants can attach to the reception sites on the reinforcing fibers and thus block the bonding of the thermoplastic material to the reception sites resulting in a less effective bond between the thermoplastic and the fibers.

Further, an adhesion promoting substance is typically added to the melt to promote and enhance the bonding of the thermoplastic material to the fiber reception sites. olorants and/or other additives added to the melt prior to the forming of bonds between the fiber reception sites and the thermoplastic can compete with the adhesion promoter for those reception sites and thus reduce the efficiency of the adhesion promoter. This results in a reduced mechanical properties, for a given length of fiber, of articles molded from the compounded melt.

Second, the present invention has determined that many colorants include abrasive materials, in particular titanium dioxide (TiO₂), which can easily damage or break reinforcing fibers, thus weakening the resulting reinforced thermoplastic material by shortening the reinforcing fibers in the melt.

Accordingly, FIG. 2 shows a system 100 in accordance with an embodiment of the present invention. System 100 preferably comprises a first extruder 104 which can comprise a plasticizing screw or the like. In system 100, the thermoplastic material (virgin material or recycled/grind) to be compounded is preferably introduced at an inlet 108 to extruder 104 along with an adhesion promoter to enhance the bonding of the thermoplastic resin to the glass fibers, when they are introduced, as discussed below.

If it is desired to include recycled/regrind material in the material introduced at inlet 108, and if that recycled/regrind material includes colorant and/or other additives, it is desired that the recycled/regrind form no more than ten percent, and preferably less, by weight of the material. As described below, colorants and/or other additives in the material to be compounded at this stage, in this case introduced via recycled/regrind materials can interfere with the bonding of the thermoplastic to the fibers and/or can damage the fibers.

As should be apparent, the present invention is not limited to polypropylene thermoplastics and other thermoplastic materials, including Nylon, PET, ABS, TPO, polyurethane, and/or the like can also be employed with the present invention. Similarly, the present invention is not limited to the use of glass fibers to reinforce the thermoplastic materials, and reinforcement fibers of other materials such as but not limited to aramid, carbon, natural fibers such as but not limited to hemp and/or the like can be employed if desired.

A conventional vent 112 can preferably be provided in extruder 104, if desired. If it is desired to include a UV blocker, and if it has been determined that the UV blocker will not compete with the thermoplastic resin for reception sites on the reinforcing fibers, then the UV blocker can preferably also be added at inlet 108. If the UV blocker, or any other desired additive, will compete for reception sites on the reinforcing fibers, then the UV blocker and/or other desired additives will preferably be added later in the compounding, as discussed below.

The resulting initial melt of thermoplastic material and adhesion promoter is preferably supplied from extruder 104 to an inlet 116 of a second extruder 120 via a suitable conduit 124. As illustrated, inlet 116 is preferably located somewhat along the length of second extruder 120, downstream of an inlet 128 through which the reinforcing fibers are preferably introduced into second extruder 120.

At inlet 128 of the second extruder 120 the reinforcing fibers with binder and sizing are introduced and preheated. Then at inlet 116 the melt from the first extruder 104 is introduced. The material is then mixed between inlet 116 and outlet 136. At this time the reinforced fibers begin debundle and mix with the thermoplastic material and adhesion promoter. The mixing continues along the second extruder 120 until a suitable mixture of the reinforcing fibers and the melt, referred to herein as an intermediate melt, has been achieved.

Next, at an access port 132, which can be a vent or other access port, colorant and, in some circumstances, a UV blocker and/or other desired additives are preferably added to the mixture in second extruder 120. It is desired that the positioning of access port 132 along second extruder 120 be such that the added colorant and other materials, if any, be sufficiently dispersed throughout the melt mixture before the final melt mixture exits second extruder 120 via exit port 136.

As should now be apparent, system 100 preferably compounds the thermoplastic melt such that the plasticized thermoplastic material and the adhesion promoter are mixed with the reinforcing fibers, allowing the thermoplastic material to substantially bond to reception sites on the reinforcing fibers with the assistance of the adhesion promoter, without competition for those reception sites which would otherwise occur from the colorant and/or UV blocker or other desired additives. Further, bonding between the reinforcing fibers and the thermoplastic material preferably occurs in the intermediate melt before the abrasives present in the colorant are introduced to the melt, thus preferably reducing the degree to which the colorant abrasives can damage and shorten the reinforcing fibers. While some bonding may occur after the colorant and other additives has been added, the majority of bonding has preferably occurred prior to this point and a melt which can be used to produce molded parts with improved mechanical properties is obtained.

The present invention is not limited to the two extruder configurations shown in FIG. 2, and FIG. 3 shows another system 200 in accordance with an embodiment of the present invention. In FIG. 3, system 200 preferably includes a single extruder 202 which is employed to compound the thermoplastic melt and extruder 202 can preferably be a single screw plasticizer, twin screw plasticizer or other suitable compounding device.

The thermoplastic material for the melt is preferably introduced, typically in the form of pellets, preferably along with an adhesion promoter to extruder 202 through inlet 204 and the thermoplastic material is preferably converted to a molten form between inlet 204 and a second inlet 208.

At inlet 208, reinforcing fibers, such as but not limited to glass fibers, are preferably introduced to extruder 202 and the glass fibers are preferably mixed with the molten thermoplastic material and adhesion promoter as the thermoplastic material is compounded along extruder 202. In this embodiment, the initial melt and intermediate melt are preferably obtained at the same time.

An access port 212 is preferably provided in extruder 202 downstream of second inlet port 208 at a distance wherein the thermoplastic material is in the form of the intermediate melt where the reinforcing fibers and the adhesion promoter have been well mixed and the thermoplastic material has substantially bonded to reception sites on the reinforcing fibers. Colorant and/or other desired additives are then preferably added to the intermediate melt through access port 212 and extruder 202 preferably mixes the melt with the colorant and/or additives to preferably disperse the colorant and/or additives throughout the melt mixture prior to the final melt exiting extruder 202 via exit port 216. From exit port 216, the final melt can preferably be supplied to a shooting pot, preform molder or to any other suitable device for using the final melt.

Again, by allowing the thermoplastic material and adhesion promoter to mix with the reinforcing fibers without the presence of the colorant and/or other additives, damage to the fibers and competition for the bonding receptor sites on the fibers is preferably avoided achieving a melt capable of produced molded parts with improved mechanical properties. The colorant is then preferably added after the bonding between the reinforcing fibers and the thermoplastic material is substantially complete.

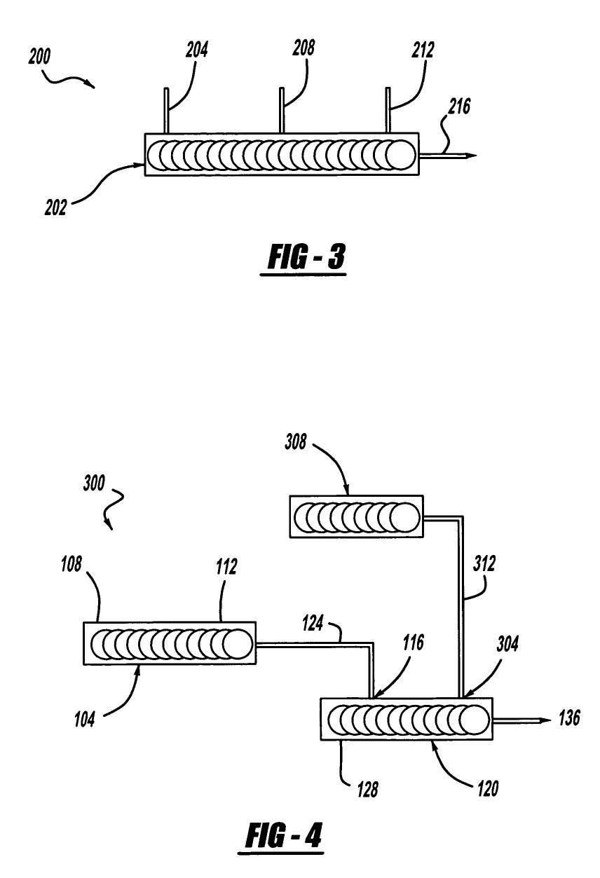

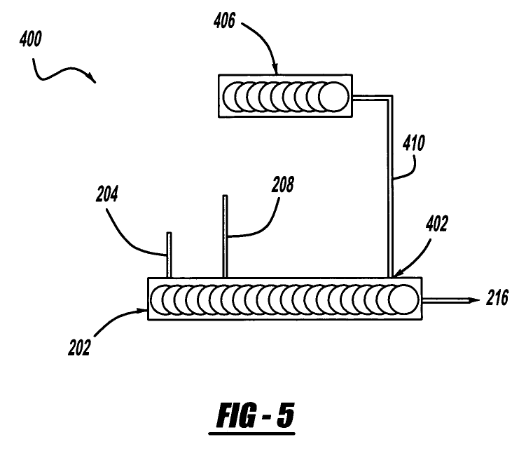

FIG. 4 shows a system 300 in accordance with another embodiment of the present invention. System 300 is similar to system 100 of FIG. 2, wherein like components have been assigned like reference numerals. In system 100 of FIG. 2, access port 132 was preferably located at a decompression zone along extruder 120 and thus colorant and/or other materials introduced via access port 132 could be gravity fed and/or the like. In system 300, access port 304 is preferably at a point along extruder 120 wherein the intermediate melt is still pressurized and thus the colorant and/or other desired additives to be introduced at access port 304 are preferably pressurized in a suitable device, such as but not limited to an extruder 308, and supplied via an appropriate conduit 312.

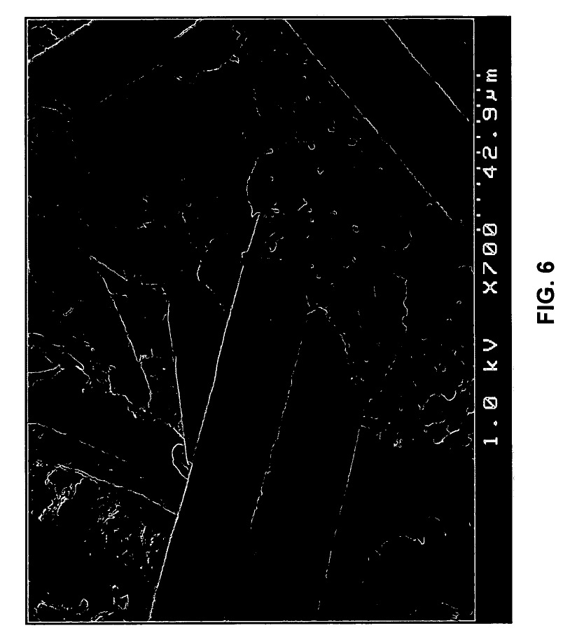

FIG. 5 shows another system 400 in accordance with another embodiment of the present invention. System 400 is similar to system 200 of FIG. 3, wherein like components have been assigned like reference numerals. Extruder 202 preferably includes an access port 402 through which the colorant and/or other materials can be added to the intermediate melt of reinforcing fibers, bond promoter and thermoplastic material in extruder 202 in accordance with the present invention, but unlike access port 212 of system 200, access port 402 is preferably not located at a decompression zone of extruder 202 and thus the materials to be added are pressurized in a suitable device, such as but not limited to an extruder 406, and preferably supplied via an appropriate conduit 410.

As will be apparent to those of skill in the art, a variety of other configurations of systems can be employed to implement the present invention. For example, the initial melt and intermediate melt can be formed in one extruder and the final melt formed in a second or each of the initial, intermediate and final melts can be formed in a respective extruder.

It is further contemplated that the present invention can also be achieved by formulating an otherwise conventional solid colorant such that the colorant is added to the extruder with the solid thermoplastic material, or otherwise before the intermediate melt is formed, but is not moltenized in the extruder until after the intermediate melt has formed. By delaying the moltenization of the colorant, the thermoplastic material and adhesion promoter mix with the reinforcing fibers with minimal, if any, competition occurring between the colorant and the adhesion promoter for the bond sites of the fibers and the fibers can form bonds before the abrasives in the colorant can significantly damage the fiber length.

A method, in accordance with the present invention, comprises the steps of combining a thermoplastic material, such as but not limited to polypropylene, with a bond promoter in a suitable plasticizer, such as but not limited to a plasticizing screw to form an initial melt. Reinforcing fibers, such a glass fibers are then preferably added to the initial melt to obtain an intermediate melt. Preferably, the reinforcing fibers been gently mixed and preheated prior to the introduction of the initial melt.

Once a suitable compounding of the initial melt and the reinforcing fibers has occurred, allowing substantial bonding to occur between the plasticized thermoplastic material and the reinforcing fibers such that the thermoplastic material has preferably formed bonds to bonding reception sites on the reinforcing fibers, to preferably obtain the intermediate melt then a colorant and/or other desired additives are preferably mixed with the intermediate melt to disperse the colorant and/or other materials through the melt to obtain the final melt. The final melt is then preferably extruded to form a molding preform or to a shot pot or mold to form a molded article.

As used above, the phrase“colorant and/or other additives are mixed with the intermediate melt” is intended to encompass both the addition of the colorant at this point in the compounding process and/or the prior addition of a solid colorant which has been formulated to delay moltenization of the colorant until after the intermediate melt has been obtained.

The compounding of the initial melt can preferably be performed in a first extruder and the mixing of the reinforcing fibers with the initial melt to obtain the intermediate melt and the mixing of the colorant and/or other desired materials can be performed in a second extruder, or all of the compounding can be performed in a single extruder.

If the colorant and/or other desired additives are introduced at a decompression or other non-pressurized region, the colorant and/or other desired additives can preferably be introduced by gravity feed or other suitable mechanism via a suitable access port. If the colorant and/or other desired additives are introduced at a pressurized region along the extruder, then the colorant and/or other desired additives can preferably be pressurized by another extruder or other suitable methods.

In tests, the present invention has achieved a 60% increase in tensile strength of molded articles formed with system 100 over those formed with prior art system 10 and it is believed that additional increases in mechanical properties can be achieved. Further, in finished molded articles made in accordance with the present invention, an increase in the average fiber lengths in the finished molded article compared to the average fiber lengths in finished molded article manufactured with prior art system 10 has been achieved. In accordance with a preferred embodiment of the present invention, the average fiber length is preferably substantially the same when measured prior to the formation of the thermoplastic melt as it is when measured after the formation of the thermoplastic melt. That is, the incidence of fiber breakage, e.g., during melt formation, is preferably reduced in the present invention so as to prevent the accumulation of relatively large amount of fiber fragments and/or dust.

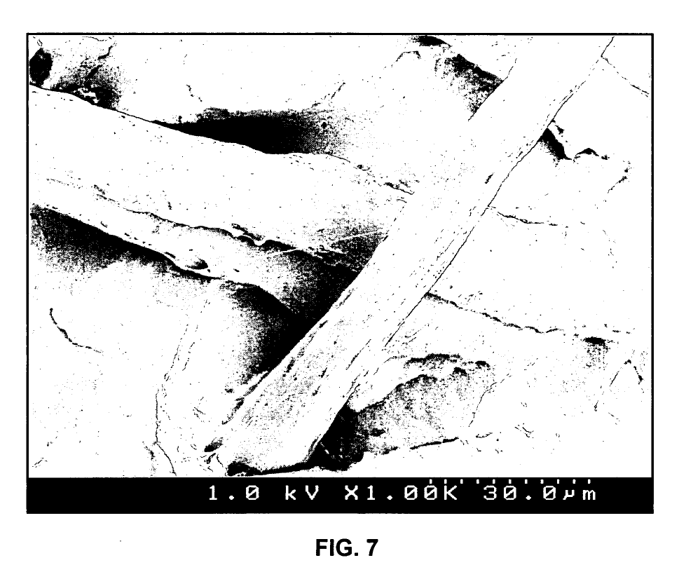

The composition of the melt yields better adhesion between the polymer materials and the reinforced fibers as well as less breakage of the fibers. These properties can be measured through impact resistance and overall toughness testing. The improved structure of the mixture can readily be seen in electromicrographs of materials made using the present process compared to materials made during conventional process. FIG. 6 shows an SEM micrograph of materials made using a conventional process and FIG. 7 shows an SEM micrograph of material made in accordance with the present invention. Clearly more polymer material has bonded to the rod shaped fibers shown in FIG. 7 than the rod shaped fibers shown in FIG. 6. The fibers shown in FIG. 7 will give articles produced with the material greater impact resistance and overall toughness.

The above-described embodiments of the invention are intended to be examples of the present invention and alterations and modifications may be effected thereto, by those of skill in the art, without departing from the scope of the invention which is defined solely by the claims appended hereto.

What is claimed is:

1. A method for compounding a thermoplastic melt for molding articles, the thermoplastic melt being reinforced with fibers, comprising:
plasticizing a mixture of thermoplastic material and an adhesion promoting agent to obtain an initial melt;
supplying fibers to the initial melt and mixing the fibers therein to allow the initial melt to bond to reception sites on the fibers to achieve an intermediate melt;
mixing to the intermediate melt at least one additive operable to inhibit bonding between the thermoplastic material and the fibers to obtain a final melt; and
supplying the final melt for molding of an article.

2. The invention according to claim 1, wherein the at least one additive includes a colorant.

3. The invention according to claim 2, wherein the colorant includes titanium dioxide.

4. The invention according to claim 1, wherein the initial melt is formed in a first extruder and the reinforcing fibers and the at least one additive are added in a second extruder.

5. The invention according to claim 1, wherein the thermoplastic material is selected from the group consisting of polypropylene, Nylon, PET, ABS, TPO, polyurethane, and combinations thereof.

6. The invention according to claim 1, wherein the fibers are selected from the group consisting of glass, aramid, carbon, natural fibers, and combinations thereof.

7. A thermoplastic melt for molding articles, comprising:
a thermoplastic material;
an adhesion promoting agent;
reinforcing fibers; and
at least one additive;
wherein the thermoplastic material and the adhesion promoting agent are mixed to obtain an initial melt;
wherein the reinforcing fibers are mixed with the initial melt to form an intermediate melt;
wherein the at least one additive is mixed with the intermediate melt to form a final melt.

8. The invention according to claim 7, wherein the adhesion promoting agent is operable to cause a substantial amount of the reinforcing fibers to adhere to the thermoplastic material.

9. The invention according to claim 7, wherein the reinforcing fibers have a length after the formation of the thermoplastic melt substantially equal to a length before the formation of the thermoplastic melt.

10. The invention according to claim 7, wherein the initial melt bonds to reception sites on the reinforcing fibers to form the intermediate melt.

11. The invention according to claim 7, wherein the at least one additive is operable to inhibit bonding between the thermoplastic material and the reinforcing fibers to form the final melt.

12. The invention according to claim 7, wherein the at least one additive includes a colorant.

13. The invention according to claim 14, wherein the colorant includes titanium dioxide.

14. The invention according to claim 7, wherein the thermoplastic material is selected from the group consisting of polypropylene, Nylon, PET, ABS, TPO, polyurethane, and combinations thereof.

15. The invention according to claim 7, wherein the reinforcing fibers are selected from the group consisting of glass, aramid, carbon, natural fibers, and combinations thereof.

16. An article formed from a thermoplastic melt, comprising:
a thermoplastic material;
an adhesion promoting agent;
reinforcing fibers, wherein the adhesion promoting agent is operable to cause a substantial amount of the reinforcing fibers to adhere to the thermoplastic material; and
at least one additive.

17. The invention according to claim 16, wherein the reinforcing fibers have a length after the formation of the thermoplastic melt substantially equal to a length before the formation of the thermoplastic melt.

18. The invention according to claim 16, wherein the at least one additive includes a colorant.

19. The invention according to claim 16, wherein the thermoplastic material is selected from the group consisting of polypropylene, Nylon, PET, ABS, TPO, polyurethane, and combinations thereof.

20. The invention according to claim 16, wherein the reinforcing fibers are selected from the group consisting of glass, aramid, carbon, natural fibers, and combinations thereof.
